(19) United States
(12) Patent Application Publication
(10) Pub. No.: US 2008/0295150 A1
(43) Pub. Date: Nov. 27, 2008

(54) METHOD FOR IMPROVING APPLICATION PERFORMANCE AND USER DIRECTORY INTEGRITY

(75) Inventor: Steve Yankovich, San Jose, CA (US)

Correspondence Address: PATENTRY, P.O. BOX 151616, SAN RAFAEL, CA, 94915-1616, US

(73) Assignee: MOVARIS CORPORATION, San Jose, CA (US)

(21) Appl. No.: 11/753,575

(22) Filed: May 25, 2007

(51) Int. Cl. H04L 9/32

(52) U.S. Cl. 726/2

(57) ABSTRACT

A method for increasing application performance while improving user directory integrity by creating an application user directory with a variety of validation policies.

### BACKGROUND

In conventional enterprise application environments, a common enterprise user directory provides access while each application has its own application user directory in addition. If the common enterprise user directory is consulted only at login, then users may have access for extended periods if they are not forced to log off. This creates a potential problem if their employment status or authority changes while they are still logged in.

Another approach is to require frequent authentication for user transactions but this can result in overloading a common enterprise user directory server or its network connection. A third approach is to mirror the enterprise user directory to better serve an application but the storage and compute resources required to host and then synchronize the master and slaved user directories becomes a maintenance project of its own.

Finally it may be appreciated that a user's role may change and responsibility withdrawn so that what they were authorized to transact or approve in the past may no longer be the case. Simply caching a enterprise user directory may defeat the purpose the function was centralized to begin with, a single point of enrollment and management.

Thus it can be appreciated that what is needed is a method for increasing both application performance and directory integrity, which supports changing roles and responsibilities, and anticipates mismatches between authority and responsibility before the collision results in a crisis of unperformed tasks.

### SUMMARY OF THE INVENTION

The present invention increases application performance and user productivity while improving security and integrity of the user directories. An enterprise may continue to check the enterprise user directory at login and allow access for receiving information as they choose. The present invention distinguishes among three application levels of security: high value transactions, operating tasks, and defining roles. Certain transactions by authorized actors will be defined to require user authentication through the enterprise user directory, the results of which are then used to refresh the application user directory. Defining tasks and responsibilities for future application activity may entail referencing a plurality of users whom the definer intends to perform tasks at some future time. A batch validation of these users and their associated information, performed off-line, is an efficient way to confirm that roles will be assigned only to those available and, in addition, flag mismatches without waiting for a crisis to surface when tasks are critical. The activity profile of the most active application users can be stored, and their authentication refreshed for the following period to ensure they have immediate access and highest of all response time at the start of the day.

The present invention comprises the steps of:
observing user authentication through the enterprise user directory for high value transactions and retaining the result in the application user directory;
validating that a group of users are found in the enterprise user directory as part of role definition of tasks and responsibilities in preparation of actual scheduling or use; and
periodically pre-validating the most active users through the enterprise user directory for the operational tasks which they most frequently perform.

### BRIEF DESCRIPTION OF FIGURES

FIG. 1 shows a schematic of a simple user directory and application.

FIG. 2 shows a schematic of two user directories and an application.

FIG. 3 shows a schematic of an application having defined roles for users.

FIG. 4 shows a schematic including a method to synchronize user directories.

FIG. 5 shows a flowchart of steps in a method for synchronizing user directories.

### DETAILED DESCRIPTION

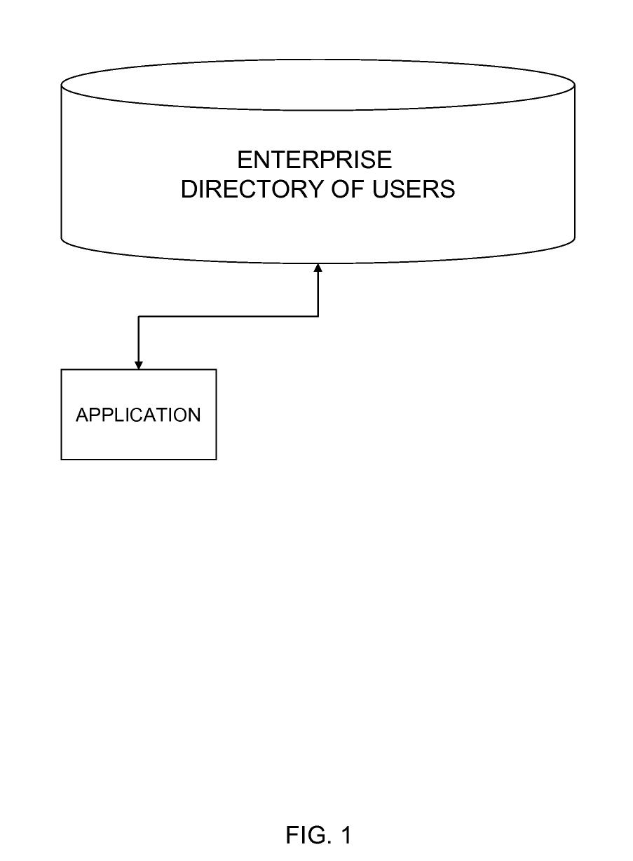

In conventional enterprise applications, a enterprise directory is checked when a user logs in, typically once at the beginning of the work day. Some applications may repeat authentication after a period of inactivity. FIG. 1 illustrates such an environment. An application may authenticate a user for each transaction, for a selected transaction, or only upon login.

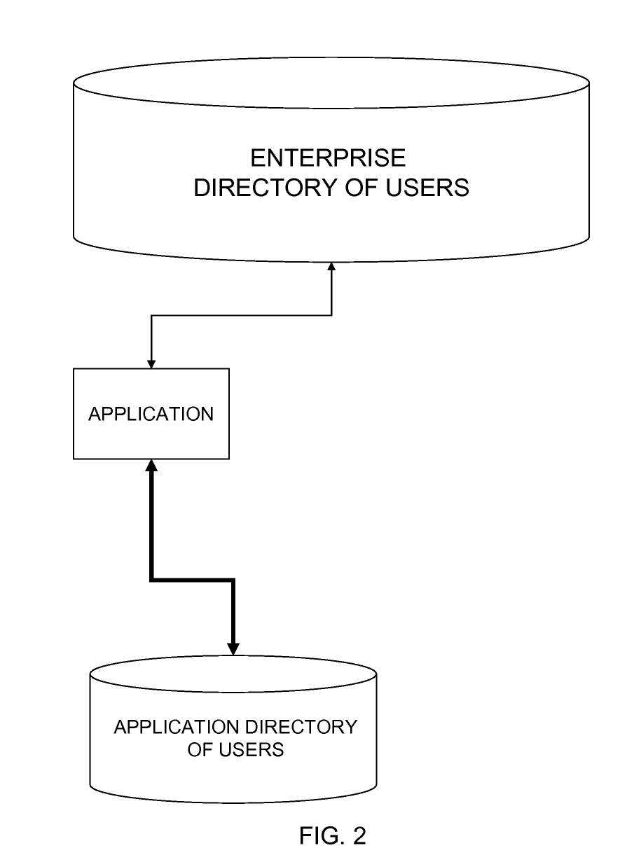

An application that authenticates every user transaction may overwhelm the enterprise directory server. Conversely an application that only authenticates on login allows a user to perform transactions after being removed from the enterprise directory. Furthermore assignment of roles to users who are no longer in the enterprise directory will only be discovered when the task or responsibility is late or missed creating a crisis. FIG. 2 illustrates an application with its own user directory but which may become incoherent with the enterprise directory of users.

An embodiment of the present invention increases performance in permission based process automation. In an enterprise network, a conventional process automation system accesses a enterprise user directory embodied in a Lightweight Directory Access Protocol (LDAP) server to authenticate users and lookup their email addresses.

However, an LDAP server is typically found on the main enterprise backbone in its own subnet. This is under the control of network administrators and is modified to add new employees or remove those who have left the company. It has fairly robust security since access to applications and data is frequently done with an LDAP operation.

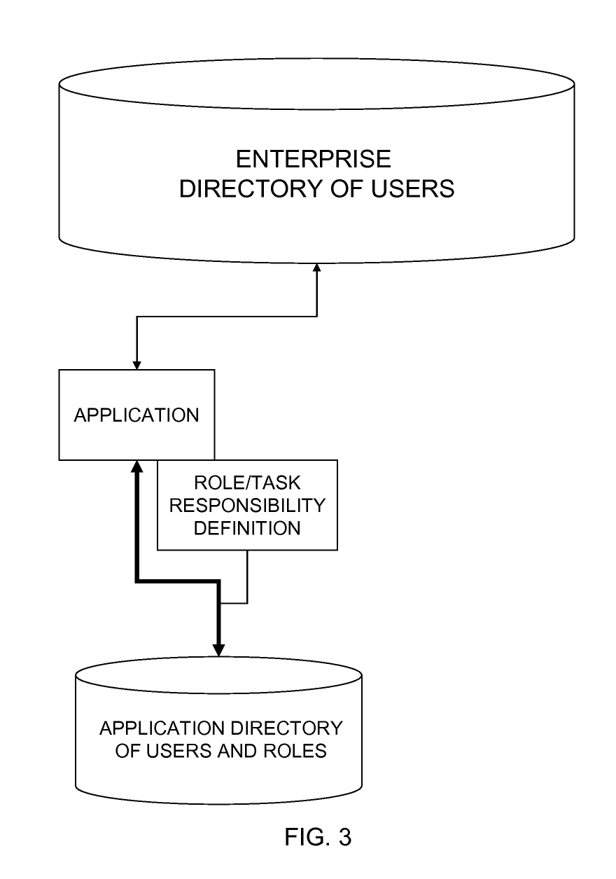

When a user of a process automation system logs in at the beginning of his workday, an LDAP request validates his or her identity. However, a process automation task can be initiated by a scheduler application based on a date or completion of other tasks which includes defining roles to individuals or groups of individuals and notification by email to large numbers of actors and their supervisors when assignment is scheduled. An automated series of LDAP requests either at definition or scheduling can overwhelm an LDAP server or clog the network connections between the LDAP server, the enterprise backbone, and the process automation subnet. FIG. 3 illustrates an application which may define different roles for each application user.

Thus the problem being solved is validating process automation assignees and email recipients without usurping LDAP integrity or overloading. The present invention comprises a method for managing an application user directory within the subnet of a process automation scheduler.

We observe firstly that the requirement for a process automation scheduler for LDAP information is limited to validate addresses not access. We observe secondly that a new employee joining a corporation is unlikely to be immediately assigned tasks on the first few days of employment. And thirdly, we note that supervisors are aware of their immediate direct reports non-availability to respond to assignments perhaps permanently non-available. So for some functions, access to LDAP is not essential in real-time.

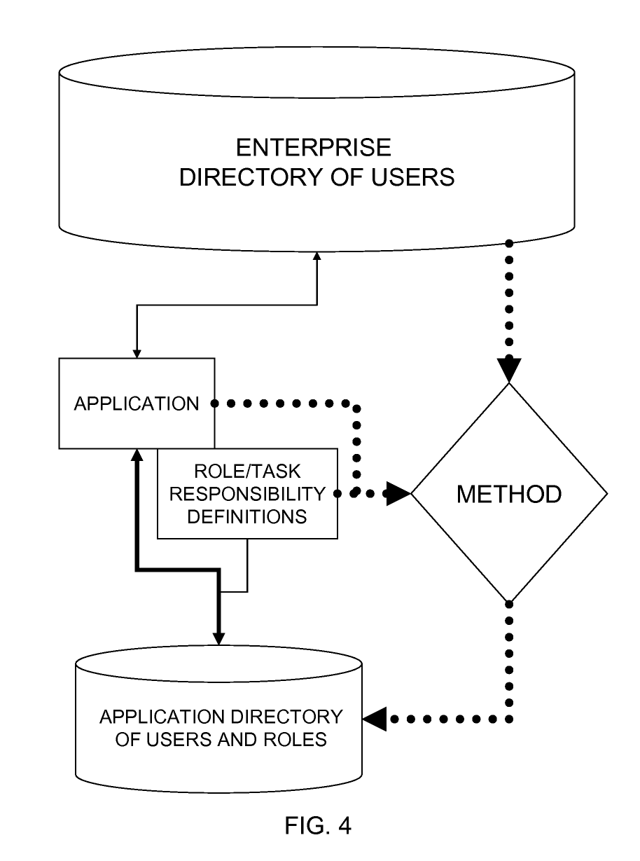

Referring now to FIG. 4 which illustrates a conventional enterprise directory of users which serves as the “golden” standard of authentication and adds the present invention, a method which references the conventional enterprise directory of users when storing a user into an application directory of users and roles. The method ensures that no member of the application directory of users and roles is not in the enterprise directory of users. An embodiment of the invention is to invoke the method when defining a new role for an application user and verify the user's listing in the enterprise directory as part of the definition process. Another embodiment of the invention is to audit at least one definition of an application role and verify each referenced user is listed in the enterprise directory and issue a warning or error message of inconsistency. Large numbers of verifications could be scheduled for a period outside of the work day if the need is not immediate.

The application user directory may in an embodiment comprise certain high value transactions whose users must be authenticated with the enterprise directory of users and other transactions which may not to balance the need for productivity and for security. An embodiment of the present invention is observing an authentication which the application requires from the enterprise directory of users and refreshing the application directory of users with the resulting status. For example, an executive may be removed from the enterprise directory of users during the work day. If the executive attempts to act or approve a certain high value transaction subsequently the application user directory will still show that the executive has that role but failing authentication with the enterprise user directory blocks the transaction. The method provides that the application user directory will be refreshed for consistency with the enterprise directory of users dynamically.

The method comprises tracing the transactions performed by the most active users over a period. On a regular interval (an interval comprising a quantity of time or number of transactions), these most active users are pre-validated with the enterprise directory of users for certain transactions for the following period. That is, if they are performing the same non-high value application transactions as they did in the prior period, and they are verified in the enterprise directory of users at the transition from one period to the next, they are pre-validated for those transactions in the next period and perceive minimum delay and higher performance from the application compared with infrequent or irregular users. For example, a process automation process may assign an application user tasks relating to closing books or paying taxes at the end of a financial period. The same application task performed by the same user at the end of the workday Friday and first thing Monday morning should have somewhat similar interactivity and productivity (after the user has been authenticated at login).

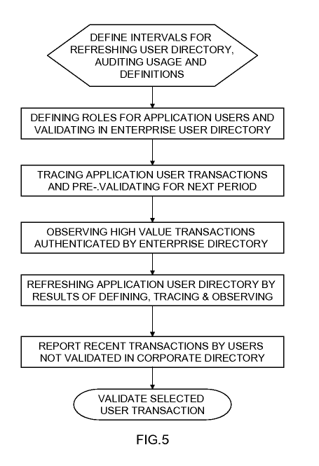

Referring now to FIG. 5 the illustration of the order of the steps in the method are not an aspect of the invention. The steps may be performed in any order, in parallel, in batch, on demand, as scheduled maintenance, or in part. The present invention comprises the step of validating that each application user defined in an application role is listed in an enterprise directory of users. The invention further comprises reporting any inconsistency between a role definition and an enterprise directory of users. The invention further comprises observing an application authenticating a user transaction with the enterprise directory of users and refreshing the application directory of users with the resulting status. The invention further comprises tracing the most active application users over a period, validating them with the enterprise directory of users at the end of the period, and pre-validating them for certain transactions for the next period.

The invention comprises a method for improving the performance and security of an application comprising the steps of storing an application directory of users and roles, comparing role definitions of a recent period with a current enterprise directory of users, and comparing user transactions of a recent period with a current enterprise directory of users. The invention comprises a method comprising the steps of storing into an application directory of users a user validation by a enterprise directory of users within a recent period and checking the application directory of users for a certain application transaction, and upon scheduled maintenance, refreshing the application directory by re-validating an application user validation with the enterprise directory current at the time of scheduled maintenance.

The invention comprises a process for building an application directory of users comprising the steps of reading a reference to a user, and validating the user in a enterprise directory of users, and storing a user validation into an application directory of users.

The invention comprises the step of reporting an issue wherein an issue comprises a definition of a role in a past period to a user not validated in the current enterprise directory, wherein a role is a task or responsibility.

The invention comprises the step of reporting an issue wherein an issue comprises a use of an application in a past period by a user not validated in current enterprise directory.

The invention comprises the steps of reading a user referenced in an application role definition, validating the user listing in an enterprise directory of users, and writing a user entry into an application directory of users. The invention comprises the steps of observing an application authentication of an application user with an enterprise directory of users, and refreshing an application directory of users with the resulting status.

The invention comprises the steps of tracing application transactions performed by a application user over a previous period, validating the application user with the enterprise directory of users at the end of the previous period, and refreshing an application directory of users with the resulting status.

### CONCLUSION

Some applications support every user in an enterprise. The present invention supports an application which has its own application user directory which is a subset of the enterprise user directory and within which different roles and responsibilities are defined for individual application users.

The present invention is a method comprising the step of verifying that application users referenced in actor/approver role definitions are found within the enterprise user directory and flagging any actor/approver role definition that references a user not found in the enterprise user directory.

The present invention further comprises the step of tracing in a previous period the most active application users and pre-validating those application users for certain application transactions in the following period.

The present invention further comprises the step of observing authentication with the enterprise user directory for certain high value application transactions and dynamically refreshing the application user directory with the resulting status.

It is to be understood that the above-described embodiments are illustrative of only a few of the many possible specific embodiments, which can represent the principles of the invention. Numerous and varied other arrangements can be readily devised in accordance with these principles without departing from the spirit and scope of the invention as fully claimed below.

What is claimed is:

1. A method for improving the performance and security of an application comprising the steps of storing an application directory of users and roles, comparing role definitions of a recent period with a current enterprise directory of users, and comparing user transactions of a recent period with a current enterprise directory of users.

2. A method comprising the steps of storing into an application directory of users a user validation by a enterprise directory of users within a recent period and checking the application directory of users for a certain application transaction, and upon scheduled maintenance, refreshing the application directory by re-validating an application user validation with the enterprise directory current at the time of scheduled maintenance.

3. A process for building an application directory of users comprising the steps of reading a reference to a user and validating the user in a enterprise directory of users, and storing a user authentication into an application directory of users.

4. The process of claim 3 further comprising reporting an issue wherein an issue comprises a reference in a past period to a user not validated in a current enterprise directory, wherein a reference is a task or responsibility intended to be assigned.

5. The process of claim 3 further comprising reporting an issue wherein an issue comprises a use of an application in a past period by a user not validated in a current enterprise directory.

6. A method comprising the steps of reading a user referenced in an application role definition, validating the user listing in an enterprise directory of users, and writing a user entry into an application directory of users.

7. The method of claim 6 further comprising observing an application authentication of an application user by an enterprise directory of users, and refreshing an application directory of users with the resulting status.

8. The method of claim 6 further comprising tracing application transactions performed by a application user over a previous period, validating the application user with an enterprise directory of users at the end of the previous period, and refreshing an application directory of users with the resulting status.
